(19) United States
(12) Patent Application Publication
(10) Pub. No.: US 2011/0313927 A1
(43) Pub. Date: Dec. 22, 2011

(54) SYSTEMS AND METHODS FOR A GIFT REGISTRY WITH STYLEBOARDS

(75) Inventors: Kristin Savilia, Bedford, NH (US); Marshall Greer, Seattle, WA (US); Janine Esposito, Irvington, NY (US); Shari Cohen, Hoboken, NJ (US)

(73) Assignees: XO Group Inc., New York, NY (US); The Knot, Inc., Brooklyn, NY (US)

(21) Appl. No.: 13/080,077

(22) Filed: Apr. 5, 2011

Related U.S. Application Data
(60) Provisional application No. 61/322,509, filed on Apr. 9, 2010.

(51) Int. Cl. G06Q 30/00; H04L 9/14

(52) U.S. Cl. 705/50; 705/26.8

(57) ABSTRACT

Systems and methods for that allow for the creation and management of a gift registry including styleboards are described. The gift registry may be a centralized gift registry. Gifts are added to the styleboards from a centralized or a retailer-specific registry. A styleboard is generated and displayed. Gift givers may view and/or select gifts from one or more the styleboards of the gift registry. In one embodiment, when a purchase of a gift occurs, the gift list and/or the styleboard(s) is updated. In one embodiment, updates to gifts are sent between the gift registry systems, such that the gifts common to these gift registries are synchronized. This synchronization may involve the use of APIs associated with the respective gift registry systems.

### CROSS-REFERENCE TO RELATED PATENT APPLICATIONS

This application claims the benefit of U.S. provisional patent application No. 61/322,509, filed Apr. 9, 2010, the entire contents of which are hereby incorporated herein in their entirety.

### BACKGROUND

This application relates generally to the field of gift registries. More particularly, this application relates to systems and methods for gift registries with styleboards.

Gift registries are known and used in a number of different markets, with the most common area being wedding registries. Gift registries may also be referred to as wish lists. Gift registries include a list of gift items (or gifts) that a gift registrant desires. Gift registrants may also be referred to as gift recipients. The advent of widespread access to communications networks such as the Internet has led to the development of web applications capable of accessing gift registries. Some gift registries are associated with an event. An event may be, for example, an engagement, wedding, anniversary, birthday, graduation, religious holiday, baby shower, baptism, confirmation, Mother's day, Father's day, or any other significant event. Such gift registries may, in addition to gift information, have event information such as type and date of an event.

Retailers that provide registry services (hosted at their own servers or by third party servers over a communications network such as the Internet) typically restrict the content of their “retailer-specific” (gift) registries to products offered by the retailer. Thus, gift registrants for major events, such as weddings, must still register with several different retailers in order to create such retailer-specific registries in order to obtain all their desired gifts. A multi-retailer registry is one in which the gift list of the gift registry is a combination of gifts from a plurality of retailers. The multi-retailer registry may be created, for example, by a gift registrant manually entering large amounts of information, such as a gift descriptions, prices, and possible retailers where the gift items can be found.

A gift list of a gift registry may be sorted by one or more categories, e.g., by price, by retailer, by quantity desired, etc. However, gift givers are not able to view the gift items in a customizable manner, i.e., as intended by the gift recipient. In this respect, gift registries are quite unsatisfactory as gift givers must search through (sorted) gift lists of the gift registry to find items that they want to purchase. Such a search is a large burden on the gift giver and, by association, the gift registrant, as the gift registrant may not be able to receive the items they most desire.

### SUMMARY

It is an objective of the present disclosure to provide systems and methods for a gift registry with styleboards, which, inter alia, allows gift givers to easily view and search through a gift list of the gift registry to find gift items that they want to purchase. The systems and methods described herein are applicable to any suitable registry, e.g., a retailer-specific registry. However, embodiments will be described below with respect to a centralized gift registry, which is a registry that includes a gift item from at least one retailer-specific registry. Such centralized gift registries are described in commonly-owned, co-pending U.S. patent application Ser. Nos. 12/757,413, 12/757,424, and 12/757,436, each of which was filed on Apr. 9, 2010. The entire contents of each of these patent applications are hereby incorporated herein in their entirety.

In one aspect, the invention relates to a gift registry system including one or more styleboards of a gift registry. A gift registry system may include a gift registry of a gift registrant. The gift registry system may also include a memory for storing the gift registry, and a network interface for communicating with a communications network. The communications network is accessible to at least one a gift giver and a gift registrant. The gift registry system may also include a processor in communication with the memory and the network interface. The processor may be configured to, e.g., generate and transmit web pages to the gift giver and/or gift registrant.

In some embodiments, one or more gifts of the gift registry are associated with one or more styleboards. In one embodiment, a styleboard includes a customized (i.e., created and edited by the gift registrant) display of the gifts pertaining to a selected styleboard category, e.g., “kitchen”, “bathroom”, “living room”, etc. Thus, a gift registry may include one or more styleboards. In one embodiment, a styleboard is automatically created and suggested to a gift registrant. In one embodiment, each styleboard is a web page that includes a display of these gifts in a manner customized by the gift registrant. Further description of styleboards appears in the material behind TAB 2 of U.S. provisional patent application No. 61/322,509. These portions of the aforementioned provisional patent application are hereby incorporated herein in their entirety. A gift registrant and/or a gift giver may view a gift list of the gift registry within one or more styleboards. For example, a gift registrant may view a gift list and add gifts from this list to the styleboard. Gifts may be added to the styleboard from a retailer-specific registry, a centralized gift registry, or a retailer catalog. In alternative embodiments, a gift registrant may add gifts to a styleboard from a retailer-specific, centralized gift registry, or retailer catalog and subsequently add the gifts from the styleboard to the gift registry. A gift giver may access a styleboard of a gift registrant to view gift items and select gift items for purchase. In some embodiments, each of the gifts of a styleboard may be displayed with appropriate indicia, e.g., the quantity of the gift desired by the gift registrant, whether the gift has been purchased, whether the gift is associated with another styleboard. A styleboard may include a suitable background, e.g., the background or base color of the web page, as well as a suitable arrangement of images of the gifts of the styleboard.

In some embodiments, the gift registry system also includes a memory for storing the attributes of a styleboard, e.g., background color, title, description, gifts, etc. The attributes may be stored in a styleboards data structure that points to or from a separate gift item data structure. For example, a styleboards data structure could include information on the styleboard categories, styleboard background colors, styleboard gifts or gift images, retailers associated with the gifts of the styleboards, or any other suitable styleboard information. In alternative embodiments, the gift item data structure may include metadata pertaining to the attributes of a styleboard. The gift registry system also includes a network interface for communicating with a communications network. The communications network is accessible to at least one gift giver and the gift registrant. The gift registry system further includes a processor in communication with the memory and the network interface. The processor of the gift registry system is configured to generate a display including a styleboard (and at least one gift) and transmit the display over the communications network to at least one of the gift giver and the gift registrant.

In some embodiments, the gift registry is a centralized gift registry that includes a gift common to the centralized gift registry and a retailer-specific registry. In these embodiments, the processor of the centralized gift registry system is further configured to receive a request to update the gift, send a request to update the gift to the respective retailer-specific registry, and modify the centralized gift registry to include the update to the gift and to the associated styleboard, thereby synchronizing the gift common to the respective retailer-specific registry and the centralized gift registry. An update may include a change in the desired quantity of the gift and/or an addition of the gift to a respective registry. The processor of the centralized gift registry system is further configured to send the request by generating an API function call to a respective retailer-specific registry system.

In some embodiments, the processor is further configured to receive a selection, by the gift registrant, of a gift to be added to a styleboard of the gift registry. The processor is also further configured to modify the styleboard of the gift registry to include the selected gift and the desired quantity. In some embodiments, the processor is further configured to receive a selection, by one of the gift registrant and the gift giver, of a desired quantity of a gift associated with a styleboard, and modifies the styleboard of the gift registry to include an indicator of the desired quantity.

In some embodiments, the memory of the gift registry system stores an application programming interface (API), and the processor receives the request via an API function call. The processor may be further configured to identify the retailer-specific registry system making the request via the API function call. In some embodiments, the API function call includes a public key, and a private key associated with a retailer-specific registry system is used to digitally sign the API function call. The processor is then further configured to determine, based at least in part on the digital signature of the API function call, the identity of the retailer-specific registry system.

In another aspect, the invention relates to a method implemented on a gift registry system. The method includes storing, by a processor of the gift registry system, a gift registry of a gift registrant in a memory of the gift registry system, The gift registry includes a gift associated with a styleboard of the gift registry. A styleboard includes a customizable display of the at least one gift and at least one of a styleboard background color, a styleboard title, a styleboard category, and a styleboard description. The method further includes receiving, by a processor, an input from a gift registrant requesting a customization of the styleboard. The processor is configured to communicate via a network interface with a communications network and with the memory, and wherein the communications network accessible to a gift giver and the gift registrant. The method further includes generating, by the processor, a display responsive to the input including the styleboard and the gift associated with the styleboard. The method further includes transmitting, by the processor, the display over the communications network to one of the gift giver and the gift recipient.

### BRIEF DESCRIPTION OF THE DRAWINGS

The detailed description below of certain illustrative embodiments of the present disclosure refers to the accompanying drawings, of which:

FIG. 1A is a block diagram of a gift registry system including a web/app server, according to an illustrative embodiment;

FIG. 1B is a block diagram of a registry web/app server, according to an illustrative embodiment;

FIG. 2 is an information flow diagram for requests sent over a communications network between a gift registry and a retailer, according to an illustrative embodiment;

FIG. 3A shows data structures that may be associated with gift items and/or styleboards of a gift registry, according to an illustrative embodiment;

FIG. 3B shows data structures that may be associated with styleboards of a gift registry, according to an illustrative embodiment;

FIG. 4 is an initial display screen for a gift registrant or gift giver, according to an illustrative embodiment;

FIG. 5A is a display screen for a gift registrant, according to an illustrative embodiment;

FIG. 5B is a display screen for a gift registrant for creating or modifying a styleboard of the gift registry, according to an illustrative embodiment; and

FIG. 6 is a process flow diagram illustrating a process for generating and transmitting a styleboard display screen of the gift registry, according to an illustrative embodiment.

### DETAILED DESCRIPTION OF CERTAIN ILLUSTRATIVE EMBODIMENTS

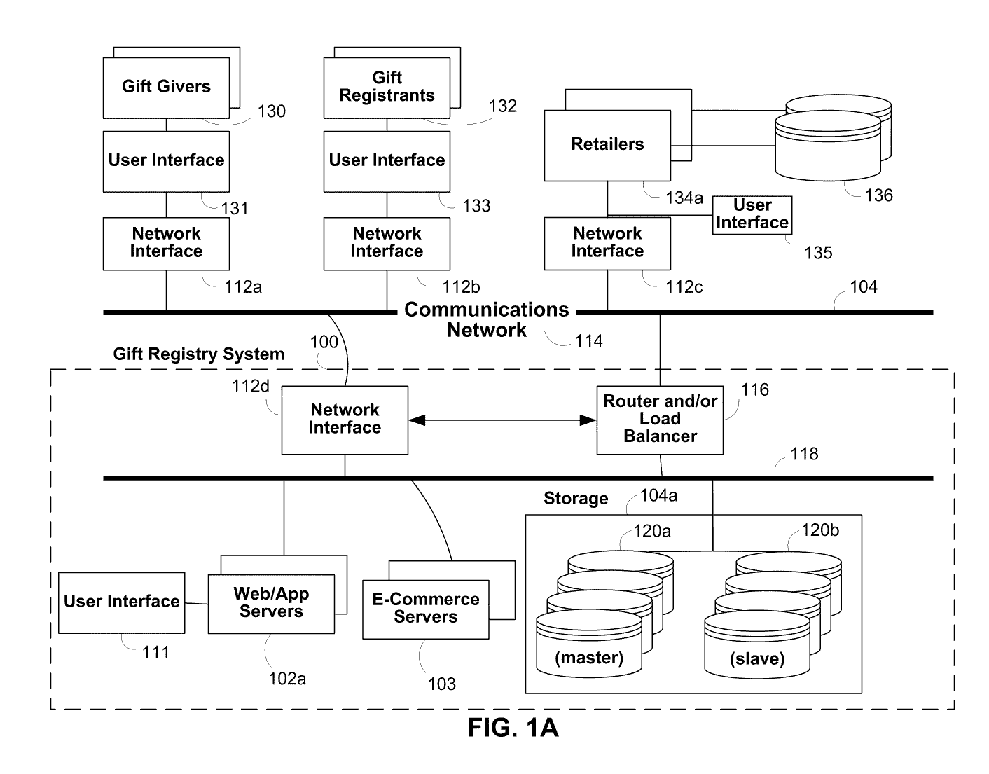

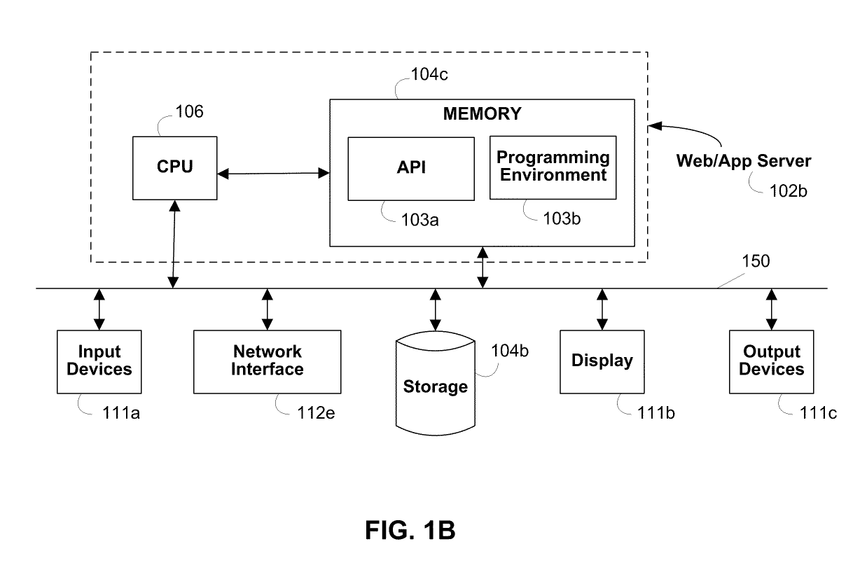

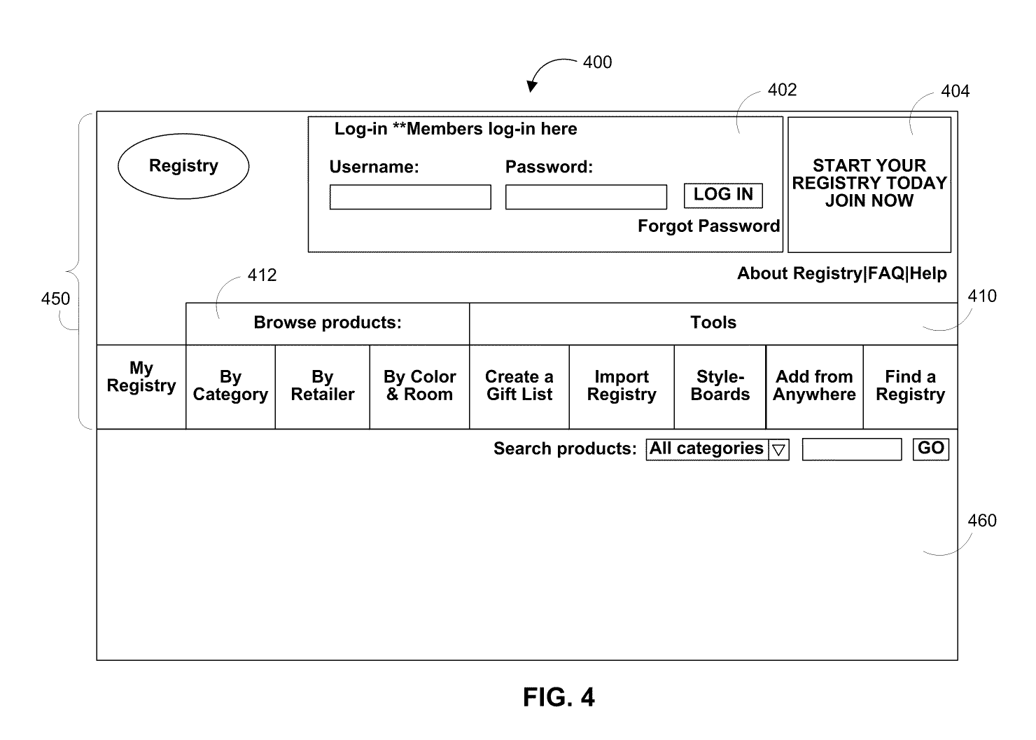

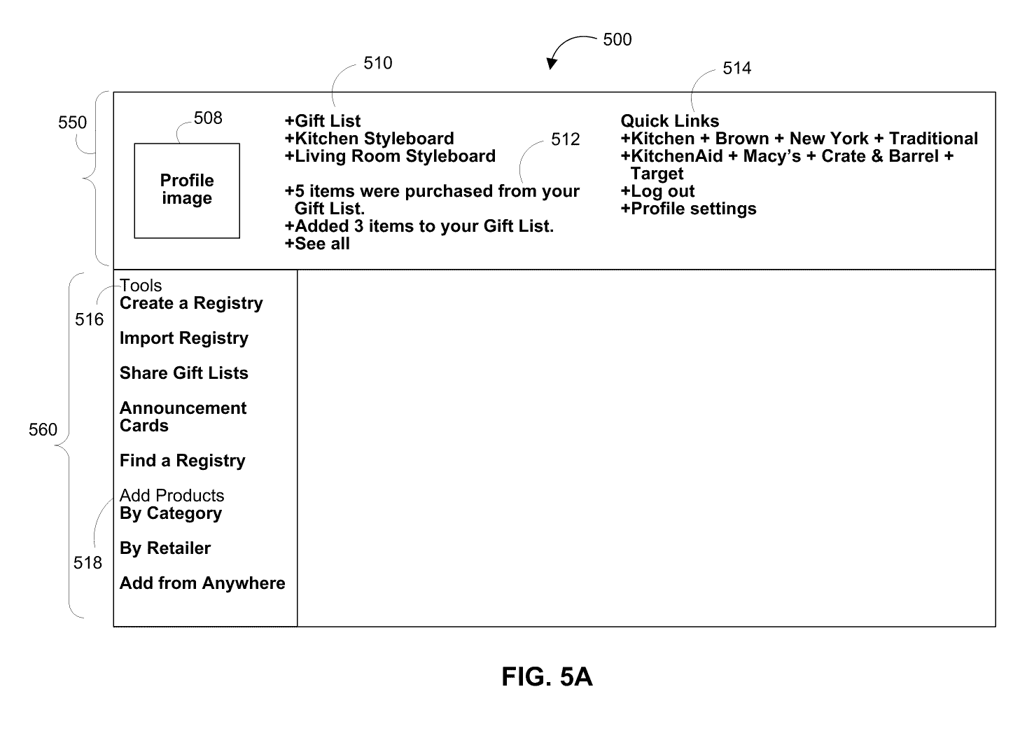

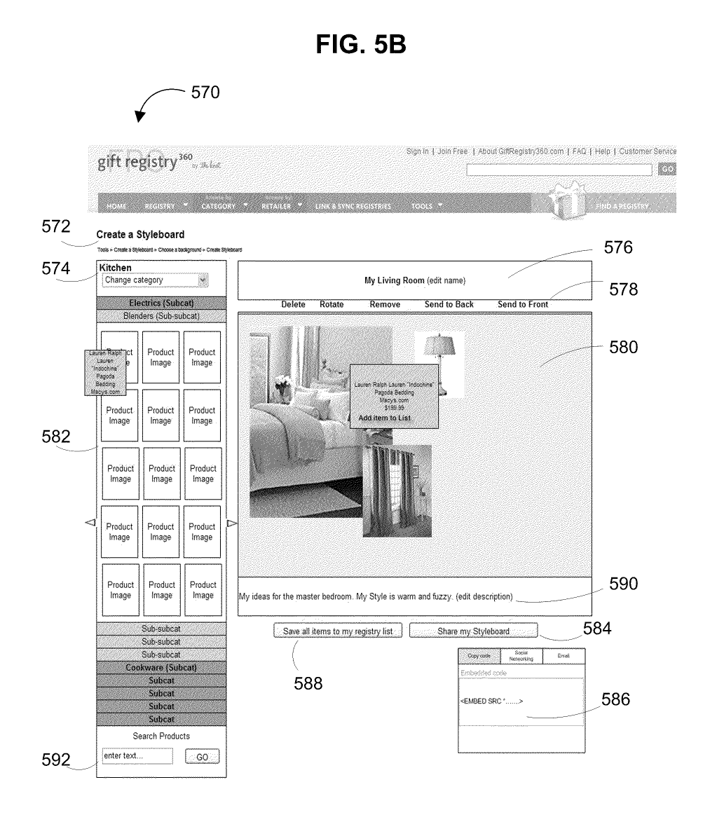

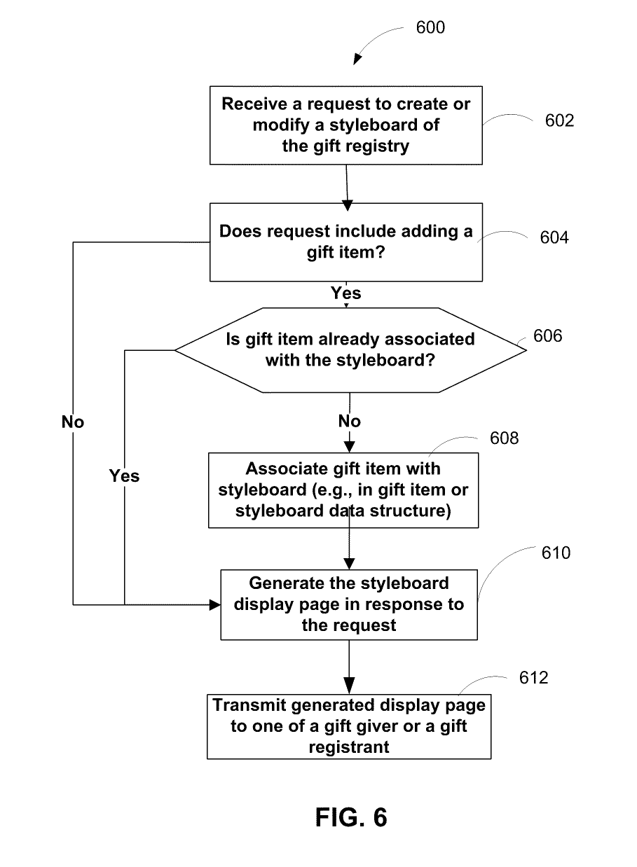

Various illustrative devices and platforms that may implement embodiments of the present gift registry system are described in more detail below with reference to FIGS. 1A, 1B, 2, 3A and 3B. Display screens for illustrative embodiments are described with reference to FIGS. 4, 5A and 5B. While the display screens of FIGS. 4, 5A and 5B are illustrated as full or partial-screen displays (e.g., web pages), they may generally be displayed in any suitable size or format. FIG. 6 contains illustrative process flow diagrams for processes that may be implemented on the gift registry systems of FIGS. 1A, 1B, 2, 3A and 3B, to generate displays (e.g., web pages), e.g., the display screens of FIGS. 4, 5A and 5B.

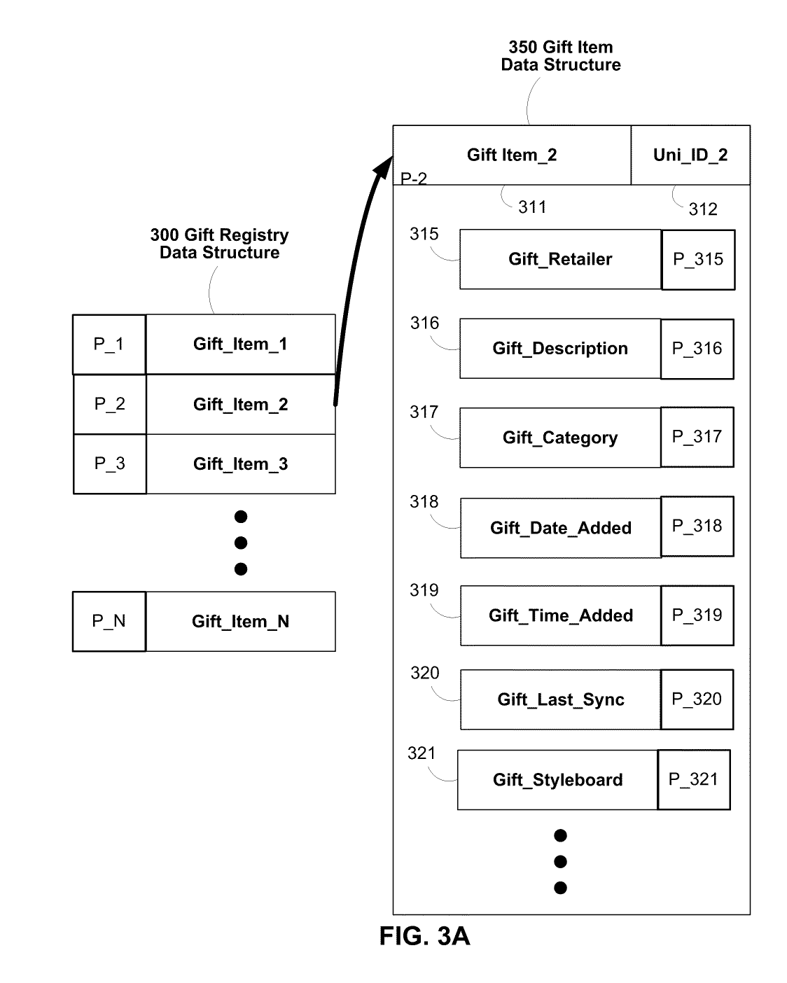

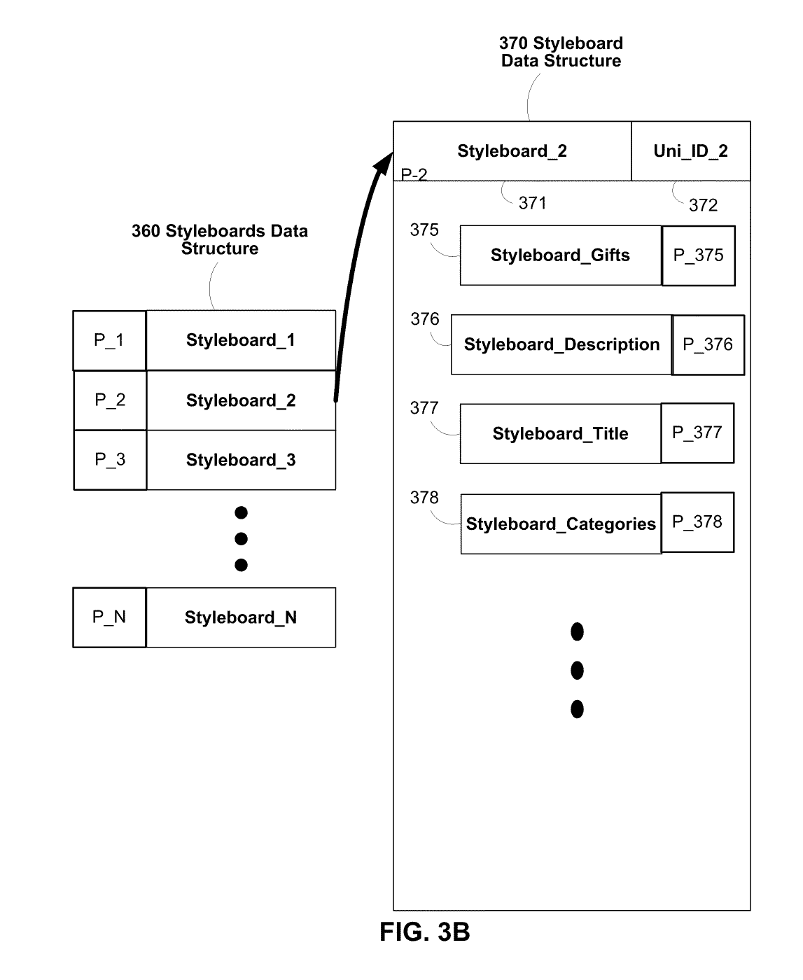

FIG. 1A shows a block diagram of a gift registry system 100, which includes one or more Internet servers/application servers or web/app servers 102a. Gift registry system may be a centralized gift registry system or a retailer-specific registry system, without limitation. In some embodiments, gift registry system 100 may include gift items from several retailer-specific registries. The web/app servers 102a (discussed further in relation to FIG. 1B) are in communication with one or more e-commerce servers 103, a storage 104a, a network interface 112d, and a user interface 111, via system network 118. The communications between these devices may be wired or wireless communications. Storage 104a may include storage devices 120a and/or storage devices 120b. Storage devices 120a and 120b may include any suitable fixed or removable storage devices, e.g., hard drives and optical drives, and include any suitable memory, e.g., random-access memory, read-only memory. This memory may be used to store any suitable information for gift registry system 100. In some embodiments, memory within storage device 136 may store computer-readable program instructions, e.g., an API, which, when executed by a processor within a computing device (not shown) at retailer system 134a, may perform a particular process. In some embodiments, memory within storage device 136 may store one or more styleboard and/or gift item data structures (described in detail below in reference to FIGS. 3A and 3B) associated with items available on gift lists for gift registrants 132, one or more gift lists common to one or more retailer systems 134a (e.g., on their retailer-specific registries) and gift registry system 100, or any other suitable information.

Network interface 112d may include a cable modem, an integrated services digital network (ISDN) modem, a digital subscriber line (DSL) modem, a telephone modem, a wireless modem, a satellite receiver, a router, a wireless or wired modem, a cellular or satellite phone, or any other suitable equipment that allows for communication between the web/app servers 102 and a communications network 114. System network 118 and communications network 114 may be any suitable wired or wireless network, including a broadcast, cable, or satellite television network and/or the Internet. User interface 111 may include a PC, a laptop, a tablet, a WebTV box, a personal computer television (PC/TV), a PC media server, a PC media center, a PDA, a mobile telephone, or any other user computer equipment, including storage devices, user input devices, and display devices. (WebTV is a trademark owned by Microsoft Corp.) Gift registry system 100 may include a router (e.g., a gateway router manufactured by Cisco Corp.) and/or a load balancer. The router may serve as a gateway between gift registry system 100 and communications network 114, while the load balancer may function to balance the storage load among the storage devices 120a and 120b in within storage 104a.

Gift registry system 100 may communicate with one or more gift givers 130, one or more gift registrants 132, and one or more retailer systems 134a over communications network 114. The retailer systems 134a host one or more retailer-specific registries. Each gift giver 130 and gift registrant 132 may have their own user equipment. The user equipment may include a user interface (131, 133, 135) and/or a network interface (112a, 112b, 112c). Retailer 134 may include a web/app server, or other suitable computer equipment capable of communicating with web/app server 102a of gift registry system 100. Each of the network interfaces 112a-c may include a cable modem, an integrated services digital network (ISDN) modem, a digital subscriber line (DSL) modem, a telephone modem, a wireless modem, a satellite receiver, a router, a wireless or wired modem, a cellular or satellite phone, or any other suitable equipment that allows for communication with communications network 114. Each user interface 131, 133, 135 may include a keyboard, a mouse, a PC, a laptop, a tablet, a WebTV box, a personal computer television (PC/TV), a PC media server, a PC media center, a PDA, a mobile telephone, or any other user computer equipment, including storage devices, user input devices, and display devices. For instance, retailer system 134a may have associated storage device 136. Storage device 136 may include memory. This memory may be used to store any suitable information for the retailer. In some embodiments, memory within storage device 136 may store computer-readable program instructions, e.g., an API, which, when executed by a processor within a computing device (not shown) at retailer system 134a, may perform a particular process. In some embodiments, memory within storage device 136 may store one or more data structures (described in detail below in reference to FIGS. 3A and 3B) associated with items available for purchase at the retailer, items on gift lists for gift registrants 132, one or more gift lists common to a retailer's retailer-specific registry system and gift registry system 100, or may store any other suitable information.

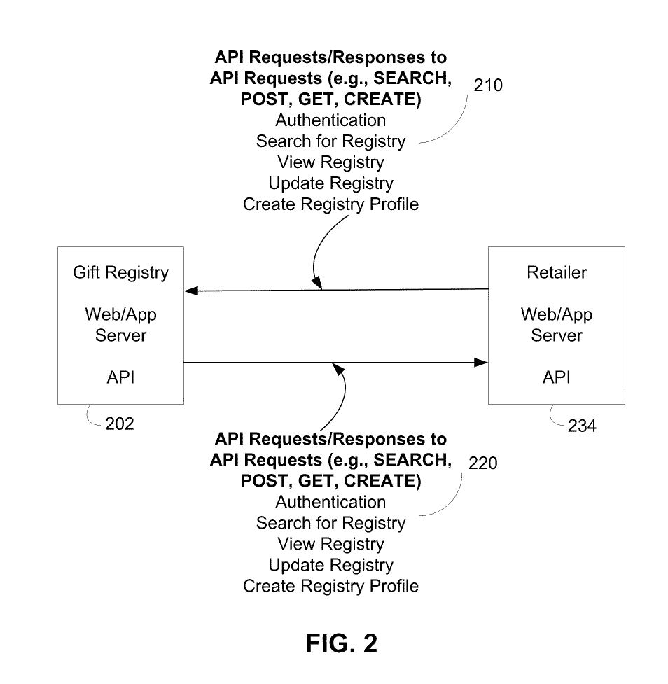

Web/app server 102a of gift registry system 100 may act as a host for a gift registry, such as a wedding registry. The gifts on the gift list of the gift registry may be stored in storage 104a in the form of any suitable data structure and using any suitable database programming environment, e.g., a MySQL database associated with a Linux or Apache server. In such an implementation, one set of storage devices 120a may act as the “master” MySQL database, while the other set of storage devices 120b may act as the “slave” MySQL database. Web/app server 102a may receive messages from a gift registrant 132 over communications network 114. These messages may include requests for creating the gift registry, requests for searching for an associated retailer-specific registry, requests for adding items to the gift registry, requests for removing items from the gift registry, requests for adding a cash gift to the gift registry, requests to pass messages to one or more gift givers, requests for removing a cash gift from the gift registry, requests for modifying display screens (e.g., web pages) of the gift registry, requests to update the gift list of the gift registry, or any other suitable requests. Each of these requests may include a request for authentication, whereby the identity of the gift registrant 132 is authenticated with the web/app server 102a. These requests may be processed by a processor of web/app server 102a using a gift registry API, as will be discussed further in reference to FIGS. 2 and 3. In response to the received requests, web/app server 102a may generate and send display screens, e.g., in http or XML format, or other information associated with the gift registry to a gift registrant 132.

Web/app server 102a may also receive messages from a gift giver 130 over communications network 114. These messages may include requests for searching for a gift registrant's registry that is associated with the gift registrant's gift registry, requests for purchasing gifts from the gift registry, requests to pass a message to a gift registrant, requests for receiving display screens including gifts from a gift registrant's gift list, requests for modifying display screens of the gift registry, or any other suitable requests. Each of these requests may include a request for authentication, whereby the identity of the gift giver 130 is authenticated with the web/app server 102a. These requests may also be processed by a processor of web/app server 102a using the gift registry system's API, as will be discussed further in reference to FIGS. 2 and 3. In response to the received requests, web/app server 102a may send display screens, e.g., in http format, or other information to the gift giver 130 or gift registrant 132.

Web/app server 102a may also receive messages from a retailer system 134a, e.g., from the retailer's retailer-specific registry system over communications network 114. These messages may include requests for searching for a gift registrant's gift registry, requests for purchasing gifts or other items from the gift registry, requests to pass a message to a gift registrant or a gift giver, requests for receiving display screens including gifts from a gift registrant's gift list, requests for modifying display screens of the gift registry, or any other suitable messages. Each of these requests may include a request for authentication, whereby the identity of the retailer 130 is authenticated with the web/app server 102a. These requests may also be processed by a processor of web/app server 102a using the gift registry API, as will be discussed further in reference to FIGS. 2 and 3. In response to the received requests, web/app server 102a may send display screens, e.g., in http format, or other information to the retailer system 134a.

In some embodiments, the e-commerce server(s) 103 (FIG. 1A) is used to process purchase requests received by the web/app server 102a. In some embodiments, e-commerce servers associated with retailer(s) 134a (FIG. 1A) are configured to process purchase requests received by either the gift registry system 100 (FIG. 1A) or an associated retailer-specific registry system. Once the purchase request has been fulfilled by an e-commerce server, an indication that the purchase request has been fulfilled may be transmitted between the gift registry system 100 (FIG. 1A) and an associated retailer-specific registry system.

FIG. 1B is a detailed block diagram of a web/app server 102b, which may be part of gift registry system such as web/app server 102a (FIG. 1A), or a retailer web/app server (not shown in FIG. 1A). Web/app server 102b includes a central processing unit (CPU) 106, and internal memory 104c. Memory 104c may include an API 103a and/or any other suitable programming environment 103b. Web/app server 102b may be in communication via network 150 with one or more input devices 111a, a network interface 112e, storage 104b, a display 111b, and one or more output devices 111c. The network interface 112e may include similar components to the network interfaces 112a-d described above in relation to FIG. 1A. Network 150 may be any suitable wired or wireless network. Storage 104b may also be similar to the storage 104a described above in relation to FIG. 1A. Display 111b may include any suitable display device, e.g., a LCD or plasma display. Input devices 111a may include a keyboard, a mouse, a remote control, or any other suitable device, while output devices 111c may include external memory or other peripheral devices that may be operable when connected to web/app server 102b via network 150.

FIG. 2 is an information flow diagram for requests sent between one or more web/app servers of a gift registry system (e.g., gift registry system 100 of FIG. 1A) and one or more web/app servers of a retailer (e.g., retailer 134 of FIG. 1A) over a communications network, such as communications network 114 (FIG. 1A). Those skilled in the art will recognize that equipment other than web/app servers may be used to initiate or respond to these requests. For example, a backend server at a retailer's system may respond to, or initiate, requests to the gift registry system.

FIG. 2 shows a gift registry system 202 including a web/app server and gift registry system's API, and a retailer 234 which may also include a web/app server and a retailer-specific registry system's API. The API may be programming language-dependent or language-independent. For example, requests via an API function call to a web/app server may be made in a particular language or format (e.g., http, XML), while responses to requests may be made in the same or a different language or format, e.g., Representational State Transfer—REST (with Extensible Mark up Language—XML) or Javascript Object Notation—JSON. In some embodiments, the retailer web/app server may send requests 210 via the gift registry system's API. Requests 210 may be made in any suitable format, e.g., http, and may include requests for authentication, requests for searching the gift registry, requests for viewing or updating a gift registry, and requests for creating a gift registrant profile with the gift registry system. In addition, the gift registry system's web/app server may send requests 220 via the retailer-specific registry system's API. Requests 210 may be sent in any suitable format, e.g., http, and may include requests for authentication, requests for searching the retailer-specific gift registry, requests for viewing or updating the retailer-specific gift registry, and requests for creating a gift registrant profile on the retailer-specific registry system.

In some embodiments, the retailer-specific and/or gift registry system's APIs are a set of “allowable” http request messages and a suitably defined set of responses. The responses may be sent in any suitable language, e.g., REST with XML or JSON. Programming references for these languages are readily available, and those skilled in the art will appreciate their availability. In some embodiments, the gift registry system API allows for a number of requests from a retailer. For instance, a retailer web/app server may be able to search for, view, create, and edit registries via API function calls to the gift registry system.

In some embodiments, each request made via the gift registry system's API must be authenticated. An API request may also be referred to as an API function call. This authentication may be performed in any suitable manner, e.g., using a client-server public-private key system, e.g., by computing a digital signature using the HMAC-SHA1 signature method. For instance, requests made by either the gift registry system or the retailer-specific registry system may be authenticated by computing a digital signature using the HMAC-SHA1 signature method. Those skilled in the art will appreciate that the retailer-specific registry system or gift registry system may digitally sign an API request using a secret private key that only these systems and the respective API web/app server know. To carry out such authentication, each gift registry system's API request may include fields such as api_key (a public key provided to the retailer-specific registry system or gift registry system that allows the API to know their identity), api_sig (e.g., a HMAC-SHA1 signature of the request that is generated by the retailer-specific registry system or gift registry system client using their private key), nonce (a unique random ID generated by the retailer-specific registry system or gift registry system to identify their request), date (the date and/or time when the request is made). In some embodiments, access to the gift registry system API may be restricted such that a retailer's system will only receive a public key and a private key string if the retailer has permission to make requests the gift registry system API. As with most public-private key systems, the private key string is used only to digitally sign the API request and is not included in the API request. On the other hand, the public key is included in each API request so that the gift registry system can determine, based at least in part on the digital signature of the API request, that the retailer-specific registry system's private key generated the API request.

In some embodiments, the retailer web/app server may host a retailer gift registry, while the gift registry web/app server will host a gift registry. The gift registry may include gift items available from multiple retailers' catalogs and/or retailer-specific registries. These gift items may be added into the gift list stored on the gift registry system (e.g., of gift registry system 100 of FIG. 1A). The retailer-specific registry system and/or the gift registry system may store information in addition to the registries themselves. This information may include information about a gift registrant (e.g., an upcoming event, contact information for the gift registrant, shipping and mailing address information for the gift registrant) and/or information regarding one or more gift items associated with the retailer's offerings. In some embodiments, the retailer web/app server does not host a retailer-specific gift registry, but may provide this information to the gift registry in response to requests made via the retailer-specific registry system's API. In some embodiments, the retailer web/app server does not host a retailer-specific gift registry, and does not include an API. In this case, the retailer may provide information to the gift registry in response to “scraping” requests (e.g., in http) it receives from the gift registry. The gift registry web/app server may also provide information to a retailer in response to requests made via the retailer-specific gift registry system's API.

There are several requests that can be made via an API to a web/app server. A “SEARCH” API request may be used to perform registry searches and query a gift registry or retailer-specific registry for registries that match the profile and/or event of a particular gift registrant. The details for such a registry may be retrieved with a request via the API. A SEARCH API request may include several fields and/or variables in any suitable format. For example, a SEARCH API request may include inter alia the fields (variables) fn (first name of gift registrant), ln (last name of gift registrant), ain (authentication information, e.g., a password associated with a respective API), em (month of gift registrant's event), ey (year of gift registrant's event), and limit (the quantity of results to return, e.g., a maximum of 100). A “GET” API request may be used to obtain a complete collection of all gifts of a gift list of the retailer-specific or gift registry. Optionally, this collection may include so-called “buy” uniform resource locators (URLs) for each gift item that can be used to determine the desired quantity and number purchased for a particular gift item. Such URLs may be transmitted to the gift registry system's API web/server from an e-commerce server, e.g., server 103 (FIG. 1A). A GET API request may include inter alia the fields (variables) fn (first name of gift registrant), ln (last name of gift registrant), gl (list of gift items), gn (number of gift items), rsrh (host of the retailer-specific registry), ain (authentication information, e.g., a password associated with a respective API), em (month of gift registrant's event), ey (year of gift registrant's event), and limit (the quantity of results to return, e.g., a maximum of 100). A “POST” API request may be used to add an item to a gift registry or to update an item on a gift registry. The gift registry system's API may be used to add/update gift registry items and respond to the requester with a “successfully added” or “pending” http message. A POST API request may include inter alia the fields (variables) fn (first name of gift registrant), ln (last name of gift registrant), ugi (gift item update, e.g., add, delete, increase quantity to x, decrease quantity to y), gn (number of gift items), rsrh (host of the retailer-specific registry), ain (authentication information, e.g., a password associated with a respective API), em (month of gift registrant's event), and ey (year of gift registrant's event).

Each of the above-described requests may require authentication by the web/app server hosting the API, as described above. A “CREATE” API request may be used to create a retailer-specific gift registry. This API request is generally used if or when the gift registry system wants to create one or more retailer-specific registries on respective retailer websites or stores, or vice-versa. A POST API request may include inter alia the fields (variables) fn (first name of gift registrant), ln (last name of gift registrant), gi (gift item information, e.g., SKU number, bar code, unique identifier), gc (gift item category, e.g., kitchen, bedding, bath), gn (number of gift items), rsrh (host of the retailer-specific registry), ain (authentication information, e.g., a password associated with a respective API), em (month of gift registrant's event), and ey (year of gift registrant's event). Those skilled in the art will come to realize that each of the above-described requests may require authentication by the web/app server hosting the API, as described above. Furthermore, each of the above-described requests may include any suitable fields and/or variables. As mentioned above, the retailer and/or gift registry systems may not include an API. In these embodiments, requests may be made using a non-API environment, e.g., “scraping” requests may be made to the gift registry or retailer web/app server, e.g., in http format.

As described above, a retailer-specific registry and/or a gift registry includes information about items on a gift list. This information may be stored in a data structure within a memory, such as memory in storage 104a (FIG. 1A) or 104b (FIG. 1B).

FIG. 3A illustrates gift registry or gift item data structures that may be associated with a retailer-specific and/or a gift registry system, without limitation. Gift registry data structure 300 may store information, i.e., metadata (e.g., Gift_Item_1, Gift_Item_2, Gift_Item_3, . . . , Gift_Item_N) and/or pointers (e.g., P_1, P_2, P_3, . . . , P_N), that is associated with one or more gift items of the gift registry. Data structure 300 may be stored in a storage device such as storage 104a (FIG. 1A) or 104b (FIG. 1B). The metadata and pointers in data structure 300 may be associated with gift items. For instance, each entry in the data structure 300 may be associated with an individual gift item, or may contain a pointer from a particular gift item to a second data structure comprising more information on that particular gift item, such as gift item data structure 350, or to other metadata stored within the memory.

In FIG. 3A, pointer P_2 associated with Gift_Item_2 is associated with gift item data structure 350. Gift item data structure 350 may include alphanumeric identifiers such as Gift_Item_2 identifier 311 and a unique identifier Uni_ID_2 312. These identifiers may alone or in combination with one another uniquely identify a gift item on the gift list of a gift registrant. In addition, gift item data structure 350 may also include other metadata and pointers associated with gift item Gift_Item_2. This metadata may include a description of a retailer which sells the gift item Gift_Retailer 315, a description of the gift item Gift_Description 316, a description of a category for the gift item Gift_Category 317, a date on which the gift item was added to the gift registry Gift_Date_Added 318, a time at which the gift item was added to the gift registry Gift_Time_Added 319, a description of the last time there was a change in any information stored in structure 350 Gift_Last_Sync 320, and a description of one or more styleboards associated with the gift Gift_Styleboard 321, e.g., “kitchen”, “living room”, “bedroom”, “dining”, or any other suitable styleboard category. Suitable Gift_Description metadata may include a text and/or image that is associated with a particular gift. Suitable Gift_Category metadata may include any suitable gift category, e.g., bedding, kitchen, glassware, flatware, and silverware. Each of these metadata may have associated pointers P_316, P_317, P_318, P_319, P_320, and P_321. These pointers may be associated with yet other gift item and/or styleboard data structures which may contain additional metadata and/or pointers. In some embodiments, a gift list may be associated with a daisy-chained set of gift item and/or styleboard data structures.

In some embodiments, data structures 300 and 350 may be used in a centralized or retailer-specific gift registry system search and/or filter task. The alphanumeric identifiers, metadata and/or pointers associated with a set of gift items, e.g., Gift_Item_1, . . . , Gift_Item_N, may be used by a suitable search or filtering algorithm to find information required by the gift registry system. For instance, the metadata Gift_Category in the gift item data structures stored in the memory of the gift registry system may be searched to find gift items of only a particular category. For instance, the gift registry system may need to find and display gift items in the “glassware” category, and may find these items by searching through the gift registry data structures for items whose “Gift_Category” metadata includes glassware.

FIG. 3B illustrates styleboard data structures that may be associated with a retailer-specific and/or a gift registry system, without limitation. Styleboards data structure 360 may store information, i.e., metadata (e.g., Styleboard_1, Styleboard_2, Styleboard_3, . . . , Styleboard_N) and/or pointers (e.g., P_1, P_2, P_3, . . . , P_N), that is associated with one or more styleboards of the gift registry. This information may include any suitable attribute for a styleboard. Styleboards data structure 360 may also be stored in a storage device such as storage 104a (FIG. 1A) or 104b (FIG. 1B). The metadata and pointers in styleboards data structure 360 may be associated with one or more styleboards. For instance, each entry in the styleboards data structure 360 may be associated with an individual styleboard, or may contain a pointer from a particular gift item to a second styleboard data structure comprising more information on that particular styleboard, such as styleboard data structure 370, or to other metadata stored within the memory.

In FIG. 3B, pointer P_2 associated with Styleboard_2 is associated with styleboard data structure 370. Styleboard data structure 370 may include alphanumeric identifiers such as Styleboard_2 identifier 371 and a unique identifier Uni_ID_2 372. These identifiers may alone or in combination with one another uniquely identify a styleboard of a gift registrant. In addition, styleboard data structure 370 may also include other metadata and pointers associated with styleboard Styleboard_2. This metadata may include a description of the gifts associated with a styleboard Styleboard_Gifts 375, a description of styleboard Styleboard_Description 376, a title for the styleboard Styleboard_Title 377, a category for the Styleboard 378 (e.g., “kitchen”, “living room”, “bedroom”, “dining”), etc. Styleboards, described further with respect to FIG. 4 below, refer to a plurality of gifts associated with a particular gift theme, e.g., gift items pertaining to a gift registrant's bedroom, living room, or kitchen on the gift registrant's gift registry. Each of these metadata may have associated pointers P_316, P_317, P_318, P_319, P_320, and P_321. These pointers may be associated with yet other gift item and/or styleboard data structures which may contain additional metadata and/or pointers. In some embodiments, a gift list may be associated with a daisy-chained set of gift item and/or styleboard data structures.

In some embodiments, styleboard data structures 360 and 370 may be used in a gift registry system search and/or filter task. The alphanumeric identifiers, metadata and/or pointers associated with a set of styleboards, e.g., Styleboard_1, . . . , Styleboard_N, may be used by a suitable search or filtering algorithm to find information required by gift registry system. For instance, the metadata Styleboard_Category in the styleboard data structure 370 may be searched to find styleboards of only a particular category.

The metadata and pointers described with respect to FIGS. 3A and 3B above are merely illustrative. Those skilled in the art will come to realize that any suitable information associated with a gift on a gift list may be stored in such styleboard or gift item data structures, and any suitable search and/or filter tasks may be performed using these styleboard or gift item data structures.

Next, we turn to illustrative display screens generated by a gift registry system, such as gift registry system 100 (FIG. 1A). In some embodiments, these display screens may be web pages generated by the web/app server 104a (FIG. 1A) or 104b (FIG. 1B) of the gift registry system 100 (FIG. 1A) and may be transmitted to a gift registrant 132 (FIG. 1A) or a gift giver 130 (FIG. 1A) over the communications network 114 (FIG. 1A), allowing these users to interact with the gift registry system 100 (FIG. 1A).

FIG. 4 is an illustrative initial display screen 400 that may be generated and transmitted, e.g., over communications network 114 (FIG. 1A), to a gift registrant or gift giver. Such a display screen may be generated by gift registry system 100 (FIG. 1A), and may be generated and transmitted, e.g., over communications network 114 (FIG. 1A), to a gift registrant or gift giver when they first attempt to access the gift registry system, i.e., before they have authenticated their identity with the gift registry system. Display screen 400 includes top section 450 and bottom section 460. Each of these sections may include images and/or text and/or video and/or a plurality of hyperlinks to other display screens that may be generated and transmitted, e.g., over communications network 114 (FIG. 1A), to a gift registrant or a gift giver. Top section 450 includes a login section 402, an advertisement section 404, a browsing toolbar 412, and a registry toolbar 410. Login section 402 includes areas in which a gift registrant or gift giver may enter a username and password for accessing the gift registry system. Advertisement section 404 may include any suitable advertisement, e.g., an advertisement for the gift registry system itself, or asking gift registrants to create a registry on the gift registry system. Browsing toolbar 412 includes hyperlinks for accessing a gift registry, and for browsing the gift registry by product, by category, by color, by room, or by retailer. Those skilled in the art will realize that other browsing categories may be used in toolbar 412.

With continued reference to FIG. 4, registry toolbar 410 includes hyperlinks for creating a gift registry or importing a retailer-specific registry into the gift registry. Optionally, registry toolbar 410 includes hyperlinks for finding a gift registry, “styleboards”, or adding gift items to a registry from anywhere (i.e., “Add from Anywhere” feature). As described above, styleboards refer to a plurality of gift items associated with a particular gift theme, e.g., gift items pertaining to a gift registrant's bedroom, living room, or kitchen on the gift registrant's gift registry. As will be described below with respect to the embodiments of FIGS. 5A and 5B, a styleboard is a web page that includes a display of this plurality of gift items. The display may include a suitable background, e.g., the base color of the web page, as well as a suitable arrangement of the gift items. Styleboards may be useful as they allow gift givers to view and/or purchase gifts that pertain to a gift registrant's gift theme. Thus, a gift giver selecting gift items may access a particular styleboard of a gift registrant to select these gift items for viewing or purchasing. Each of top section 450 or bottom section 460 may include other menus (e.g., drop-down menus), toolbars, or areas that include options and/or hyperlinks for navigating through display screens that may be generated by the gift registry system.

In some embodiments, when a gift registrant selects the styleboards hyperlink, the gift registrant will be able to access a web page generated by the gift registry system which explains the concept of styleboard and directions for creating and editing styleboards. In some embodiments, a gift registrant may create or modify a background for a styleboard. In some embodiments, a gift giver or gift registrant may view the gift list of the gift registry as a styleboard. For example, a gift registrant may view their gift list add more gift items to the styleboard, e.g., from a retailer catalog or retailer-specific registry.

FIG. 5A is an illustrative initial display screen 500 that may be generated and transmitted, e.g., over communications network 114 (FIG. 1A), to a gift registrant. Such a display screen may be generated by gift registry system 100 (FIG. 1A), and may be generated and transmitted to a gift registrant once they have authenticated their identity with the gift registry system. Such authentication may be performed, e.g., by entering a password and username in area 402 of display screen 400 (FIG. 4). Display screen 500 includes top section 550 and bottom section 560. Each of these sections may include images and/or video and/or text and/or a plurality of hyperlinks to other display screens that may be generated and transmitted, e.g., over communications network 114 (FIG. 1A), to the gift registrant. Top section 550 may include a profile image 508 supplied by the gift registrant. Top section 550 may additionally, or optionally, include selected hyperlinks to other display screens 510, including links to “kitchen” and “living room” styleboards, quick links to other display screens 512, and links 514 to recent updates to the gift registrant's gift list. Bottom section 560 may include a toolbar 516 for creating or importing gift items into the gift registry, sharing gift lists, creating announcement cards (e.g., “Save the Date” cards), and finding a registry. Bottom section 560 may also include an “Add Products” toolbar 518. The add products toolbar 518 may be used to add products by category, by retailer, or using the “add from anywhere” feature of some embodiments of the gift registry system. Those skilled in the art will realize that there are many variants of the display screen shown in FIG. 5A, including, e.g., additional toolbars for navigating through the display screens of the gift registry.

FIG. 5B is a display screen 570 that may be generated and transmitted by CPU 106 (FIG. 1B) of the gift registry system 100 (FIG. 1A) to a gift registrant for creating or modifying a styleboard of the gift registry. Display screen 570 includes a toolbar 572 that could be used to create or modify a styleboard. In the embodiment of FIG. 5B, display screen 570 includes a styleboard category label (“kitchen”) 572 and a plurality of gift items 582 represented as images. The styleboard category 572 may also include subcategories as illustrated in FIG. 5B. For example, if a gift registrant selects “kitchen”, they may see associated subcategories such as “cookware” or “electrics. A gift registrant interacting with the display screen 570 may select gift items 582, available from one or more retailers, to add to the styleboard by selecting (e.g., clicking) the associated gift item images. In some embodiments, a user may “drag and drop” gift item images from this area of the display screen 570 to the styleboard area 580. In some embodiments, a gift registrant may roll over the gift item image and the gift item retailer, price, and product name may be displayed in a pop-up display screen, as shown in FIG. 5B. Search toolbar 592 can be used to enter text to search for particular retailer gift items. The styleboard 580 includes a title 576, an editing toolbar 578 (e.g., to delete, drag and drop, resize, rotate, change from front to back or vice-versa, the images on the styleboard), and a description 590. The styleboard may also have a suitable color for the background. The styleboard title, description, or data associated with gift items of the styleboard may be stored in the gift item data structure 350 (FIG. 3). The title and description of the styleboard may be selected by the gift registrant, or may be automatically generated by the gift registry system 100 (FIG. 1A).

In some embodiments, a gift registrant may create styleboard 570 by adding retailer gift items 582 to the styleboard 570 without adding these items to the gift list of the gift registry. In these embodiments, a button such as button 588 may be used to add the gift items from the styleboard to the gift list of the gift registry.

In some embodiments a styleboard may be shared by the gift registrant, e.g., using button 584. For example, a styleboard may be linked to a social networking website such that the members of the gift registrant's network can view the shared styleboard. In some embodiments, by clicking on button 584, the embedded software code overlay 586 associated is displayed. This embedded software code overlay 586 may include code that may be copied by the gift registrant for use in another display screen, a link to one or more social networking sites, or an option to e-mail a hyperlink to the styleboard.

In some embodiments, each of the styleboard title 576, description 590, background color, or gift items associated with the styleboard 582 may be modified by a gift registrant. In making such a modification, a request is transmitted from the gift registrant to the processor of the gift registry system 100 (FIG. 1), as described further with respect to FIG. 17.

FIG. 6 is a process flow diagram illustrating a process 600 for generating and transmitting a styleboard display screen, according to an illustrative embodiment. While this embodiment refers to a gift registry system, the process described herebelow is applicable to any suitable registry, e.g., a retailer-specific registry. Process 600 begins when CPU 106 (FIG. 1B) of gift registry system 100 (FIG. 1A) receives a selection of creation or modification of a styleboard of the gift registry system (602). The selection may be received from a gift registrant, e.g., in displays (e.g., web pages) generated and transmitted to the user such as display screens 1100 (FIG. 6) or 1250 (FIG. 12B). CPU 106 (FIG. 1B) of gift registry system 100 (FIG. 1A) then determines if the request includes the addition of a gift item (604) to the gift registry. If there is a gift item to be added, the CPU 106 (FIG. 1B) of gift registry system 100 (FIG. 1A) determines if the gift item is already associated with the styleboard (606). If the gift item(s) are not associated with the styleboard, then CPU 106 (FIG. 1B) of gift registry system 100 (FIG. 1A) associates the gift item(s) with the styleboards (608). This associate may involve adding the gift to a styleboards data structure (e.g., data structures 360 and 370 of FIG. 3B) and/or gift item data structures (e.g., data structures 300 and 350 of FIG. 3A). If there is no gift item to be added (i.e., the request to create or modify the styleboard includes additions or modifications to the styleboard background color, title, description, etc.), or if the gift items to be added are already associated with a styleboard, CPU 106 (FIG. 1B) of gift registry system 100 (FIG. 1A) generates a styleboard display page or screen (similar to display screen 570 of FIG. 5B) (610). Optionally, once the styleboard has been modified, the generated display screen may be transmitted to one of a gift giver or the gift registrant (612).

Generally, the methods described herein may be executed on a conventional data processing platform such as an IBM PC-compatible computer running the Windows operating systems, a SUN workstation running a UNIX operating system or another equivalent personal computer, server, or workstation. Alternatively, the system may include a dedicated processing system that includes an API programming environment.

The methods described herein may also be realized as a software component operating on a conventional data processing system such as a UNIX workstation. In such an embodiment, the methods may be implemented as a computer program written in any of several languages well-known to those of ordinary skill in the art, such as (but not limited to) C, C++, FORTRAN, Java, MySQL, Perl, Python, Apache or BASIC. The methods may also be executed on commonly available clusters of processors, such as Western Scientific Linux clusters.

The methods disclosed herein may be performed in either hardware, software, or any combination thereof, as those terms are currently known in the art. In particular, the present method may be carried out by software, firmware, or microcode operating on a computer or computers of any type. Additionally, software embodying the processes described herein may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Accordingly, the systems and methods described herein are not limited to any particular platform, unless specifically stated otherwise in the present disclosure.

The systems and methods disclosed herein may be embodied in other specific forms without departing from the spirit or essential characteristics thereof. The foregoing embodiments are therefore to be considered in all respects illustrative, rather than limiting of the disclosure.

What is claimed is:

1. A gift registry system comprising:
a gift registry of a gift registrant including a gift associated with a styleboard of the gift registry, wherein a styleboard includes a customizable display of the at least one gift and at least one of a styleboard background color, a styleboard title, a styleboard category, and a styleboard description;
a memory for storing the gift registry; and
a network interface for communicating with a communications network, the communications network accessible to a gift giver and the gift registrant;
a processor in communication with the memory and the network interface, the processor configured to:
receive an input requesting a customization of the styleboard;
generate a display responsive to the input including the styleboard and the gift associated with the styleboard; and
transmit the display over the communications network to one of the gift giver and the gift recipient.

2. The system of claim 1, wherein the gift registry is a centralized gift registry and the gift registry system is a centralized gift registry system, and the communications network is accessible to at least one retailer-specific registry.

3. The system of claim 2, wherein the processor is further configured to:
receive a request to update the gift;
send a request to update the gift to the respective retailer-specific registry;
modify the centralized gift registry to include the update to the gift, thereby synchronizing the gift common to the respective retailer-specific registry and the centralized gift registry.

4. The system of claim 3, wherein an update includes a change in the desired quantity of the gift.

5. The system of claim 3, wherein an update includes an addition of the gift to a respective registry.

6. The system of claim 3, wherein the processor is further configured to identify the retailer-specific registry system making the request via the API function call.

7. The system of claim 6, wherein
the API function call includes a public key, and
a private key associated with a retailer-specific registry system is used to digitally sign the API function call, and
the processor is further configured to:
determine, based at least in part on the digital signature of the API function call, the identity of the retailer-specific registry system.

8. The system of claim 3, wherein the processor is further configured to send the request by generating an API function call to the respective retailer-specific registry system.

9. The system of claim 1, wherein the processor is further configured to:
receive a selection, by the gift registrant, of a gift to be added to the styleboard of the gift registry; and
modify the styleboard of the gift registry to include the selected gift.

10. The system of claim 1, wherein the processor is further configured to:
receive a selection, by the gift registrant, of a desired quantity of the gift associated with the styleboard; and
modify the styleboard of the gift registry to include the desired quantity.

11. The system of claim 1, wherein the processor is further configured to:
receive a selection, by the gift registrant, of an attribute associated with the styleboard; and
modify the styleboard of the gift registry to reflect the desired attribute.

12. The system of claim 8, wherein the desired attribute includes one of a styleboard background color, a styleboard title, a styleboard category, and a styleboard description.

13. The system of claim 1, wherein the one or more styleboards of the centralized gift registry include at least one gift from a retailer's catalog.

14. The system of claim 1, wherein the memory stores an application programming interface (API), and the processor is further configured to:
receive a request to update the gift via an API function call; and
send a request to update the gift to a retailer-specific registry system.

15. The system of claim 14, wherein the processor is further configured to identify the retailer-specific registry system making the request via the API function call.

16. The system of claim 15, wherein
the API function call includes a public key, and
a private key associated with a retailer-specific registry system is used to digitally sign the API function call, and
the processor is further configured to:
determine, based at least in part on the digital signature of the API function call, the identity of the retailer-specific registry system.

17. The system of claim 1, wherein gifts associated with the one or more styleboards of the gift registry are stored in a styleboards data structure of the memory.

18. The system of claim 1, wherein gifts associated with the one or more styleboards of the gift registry are stored in a gift item data structure of the memory.

19. A method implemented on a gift registry system comprising:
storing, by a processor of the gift registry system, a gift registry of a gift registrant in a memory of the gift registry system, wherein
the gift registry includes a gift associated with a styleboard of the gift registry, and
wherein a styleboard includes a customizable display of the at least one gift and at least one of a styleboard background color, a styleboard title, a styleboard category, and a styleboard description;
receiving, by a processor, an input requesting a customization of the styleboard, wherein the processor is configured to communicate via a network interface with a communications network and with the memory, and wherein the communications network accessible to a gift giver and the gift registrant;
generating, by the processor, a display responsive to the input including the styleboard and the gift associated with the styleboard; and
transmitting, by the processor, the display over the communications network to one of the gift giver and the gift recipient.
